(19) United States
(12) Patent Application Publication
(10) Pub. No.: US 2007/0237129 A1
(43) Pub. Date: Oct. 11, 2007

(54) Method and system for automatic intruder blocking on an Internet Protocol based network

(75) Inventor: Dennis Sych, Richboro, PA (US)

Correspondence Address: DENNIS SYCH, 20 CAROL LANE, RICHBORO, PA, 18954, US

(73) Assignee: DENNIS SYCH, RICHBORO, PA (US)

(21) Appl. No.: 11/398,362

(22) Filed: Apr. 6, 2006

(51) Int. Cl. H04L 12/66

(52) U.S. Cl. 370/352; 370/401

(57) ABSTRACT

A system and method for automatic blocking of Internet Protocol addresses based on analysis of information provided by various security systems by different vendors.

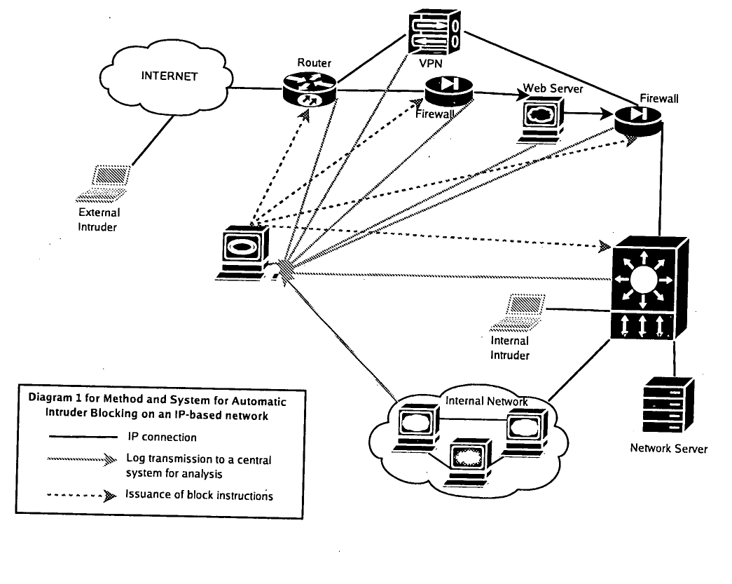

### BACKGROUND OF THE INVENTION

Due to the variety of communications and digital security devices currently available on the market, a unified system is needed to allow corporate and individual entities to protect their information assets.

Incompatibility among various communications and digital security devices require corporate and individual entities to possess extended knowledge of the various equipment to ensure adequate coverage, which raise the cost and complexity of maintaining of the security controls on the networked devices.

The present invention aims at reducing complexity surrounding management of the security of networked systems, as well as providing a method for automatic blocking without requiring manual operator intervention, but rather relying on the intelligence of computer systems for deriving conclusions as to the requirement of such action.

### SUMMARY OF THE INVENTION

In accordance with the present invention, a system and method are disclosed to issue automatic blocking of communication in an IP network.

It is therefore an object of the present invention to provide a method and a framework for issuance of automatic blocks on the communication and digital security devices based on the analysis of IP communications to determine a hostile intent of such communication.

### BRIEF DESCRIPTION OF THE DRAWINGS

Diagram 1 represents the various devices feeding events into the centralized system; and the centralized system issuing blocking instructions to the communication devices.

1. A system for automatic issuance of blocking instructions to an Internet Protocol network communications device with packet-filtering capabilities

2. The system claimed in 1 is comprised of electronic code

3. The system in claim 1 will interface with devices such as a router, a firewall, an virtual private networking device, an Intrusion Prevention System, and any such device that provides connectivity and packet-filtering capabilities.

4. The system of claim 1, wherein the system has the ability to interface with the communication devices described in claim 1, and issue blocking statements, according to the specifications of various vendors.

5. The system of claim 1, wherein the system obtains the security information from various networked systems, including but not limited to firewalls, routers, virtual private network devices, various operating systems, anti-virus systems, authentication systems, and other systems, in order to analyze and compare events based on time, Internet Protocol (IP) address of the source of the communication, and IP address of the destination of the communication, and other such information such as vulnerability information of the destination.

6. The system of claim 1, wherein the system determines the hostile intent of the source of the communication based on the method described in claim 4, and issues a blocking instructions to the communication devices that is closest to the source of the attack.

7. The method of system of claim 5, wherein the blocking instructions will be issued specific to the device using the mechanism provided by the vendor through the available interface, such as command line interface, or Simple Network Management Protocol (SNMP) interface.

8. The method of system of claim 5, wherein the method is dependent on the interface provided by the vendor and will follow the following model:
a) The communication is blocked based on the source IP address and IP port used in the attack for a specific period of time, such as 24 hours on the first hostile communications attempt.
b) The communication is blocked based on the source IP used in the attack for a specific period of time, such as 24 hours on the second hostile communications attempt.
c) The communication is blocked based on the source IP used in the attack for a longer period of time such as 72 hours, or indefinitely.

7. The method of system of claim 5, wherein the method is dependent on the interface provided by the vendor and will follow the following model:
a) The communication is blocked based on the source IP address for a specific period of time, such as 24 hours on the first hostile communications attempt.
b) The communication is blocked based on the source IP used in the attack for a longer period of time such as 72 hours, or indefinitely.

8. The method of system of claim 5, wherein the method is dependent on the interface provided by the vendor and will follow any model that is not described in the above but will allow interface with various devices by different vendors, and thereby provide a unified framework for blocking IP communications, port-specific, IP-specific, or otherwise.
